(19) United States
(12) Patent Application Publication
(10) Pub. No.: US 2009/0268007 A1
(43) Pub. Date: Oct. 29, 2009

(54) PRINTER

(75) Inventors: Toshiharu Sekino, Izu-shi (JP); Kenji Eoka, Sunto-gun (JP); Kousuke Takahashi, Sunto-gun (JP); Takeshi Hiyoshi, Mishima-shi (JP); Tsuyoshi Sanada, Ang Mo Kio (SG); Akira Suzuki, Ang Mo Kio (SG)

Correspondence Address: TUROCY & WATSON, LLP, 127 Public Square, 57th Floor, Key Tower, CLEVELAND, OH, 44114, US

(73) Assignees: TOSHIBA TEC KABUSHIKI KAISHA, Tokyo (JP); NCR CORPORATION, Dayton, OH (US)

(21) Appl. No.: 12/497,950

(22) Filed: Jul. 6, 2009

Related U.S. Application Data
(62) Division of application No. 11/681,910, filed on Mar. 5, 2007.

(30) Foreign Application Priority Data
Jun. 29, 2006 (JP) 2006-178945
Jun. 29, 2006 (JP) 2006-178946
Jun. 29, 2006 (JP) 2006-178951
Jun. 29, 2006 (JP) 2006-178956
Jan. 26, 2007 (JP) 2007-016592
Jan. 26, 2007 (JP) 2007-016593

(51) Int. Cl. B41J 2/325

(52) U.S. Cl. 347/218

(57) ABSTRACT

A printer comprising a main unit, a cover, a first print head provided in the cover, a second print head provided in the main unit, and a hinge mechanism. The cover can rotate around the hinge mechanism, between a first state and a second state in which the cover is opened and closed, respectively, with respect to the main unit. The first print head and the second print head can rotate along the locus of the cover.

### CROSS-REFERENCE TO RELATED APPLICATIONS

This application is a Division of and claims the benefit of priority from application Ser. No. 11/681,910 filed on Mar. 5, 2007, which is based upon and claims the benefit of priority from prior Japanese Patent Applications No. 2006-178945, filed Jun. 29, 2006; No. 2006-178946, filed Jun. 29, 2006; No. 2006-178951, filed Jun. 29, 2006; No. 2006-178956, filed Jun. 29, 2006; No. 2007-016592, filed Jan. 26, 2007; and No. 2007-016593, filed Jan. 26, 2007, the entire contents of all of which are incorporated herein by reference.

### BACKGROUND OF THE INVENTION

1. Field of the Invention

The present invention relates to a printer that can print data on both sides of a paper.

2. Description of the Related Art

As disclosed in, for example, Jpn. Pat. Appln. KOKAI Publication No. 11-286147, double-side printing mechanisms that can print data on both sides of a paper at the same time are known. Of these mechanisms, one that uses thermal head to print data on both sides of a thermal paper is known in particular. In this double-side printing mechanism, a first printing unit having a first thermal head and a first platen roller and a second printing unit having a second thermal head and a second platen roller are arranged symmetrical with respect to the paper-feeding path.

In this double-side printing mechanism, the first thermal head prints data on a thermal paper and then the second thermal head prints data on the thermal paper, thereby printing data on both sides of the thermal paper.

The configuration of the double-side printing mechanism described above can be applied to a thermal printer having a cover that can be opened and closed. The main unit of this thermal printer incorporates, for example, only the first platen roller and the second thermal head. The first thermal head and the second platen roller are arranged in the cover.

In order to ensure a predetermined pressure, the thermal printer is so configured that the first thermal head and the second thermal head are pushed onto the platen rollers by compression springs. Further, the thermal printer is so designed that the first thermal head and the second thermal head are rotated by predetermined strokes.

In the thermal printer so configured as described above, the cover may be closed while the first thermal head and the second thermal head remain displaced by the predetermined strokes. In this case, the first thermal head and the second thermal head may interfere with any other components, possibly damaging the components.

Of single-sided thermal papers, one is known on which timing marks such as black dots are printed, indicating the position where the paper should be cut. The timing marks are printed beforehand on the reverse side (i.e., the side that has no thermosensible layers). The conventional double-side thermal printer cannot utilize the timing marks when this single-sided thermal paper is used. The conventional double-side thermal printer should therefore be improved to enhance its versatility.

U.S. Pat. No. 6,784,906 discloses a printer of this type. In this printer, the first printing unit and the second printing unit are provided in the paper-feeding path, positioned downstream and upstream, respectively, with respect to the direction in which a paper is being transported, and print data on both sides of a paper at the same time while the paper.

The first printing unit comprises a first thermal head, i.e., print head, and a first platen roller that is opposed to the first thermal head across the paper-feeding path and is configured to transport a paper. The second unit comprises a second thermal head, i.e., print head, and a second platen roller that is opposed to the second thermal head across the paper-feeding path and is configured to transport the paper.

The printer starts printing data on a paper when the paper is wrapped is stretched between the first and second printing units. Since the positions where the first and second printing units start printing, respectively, are deviated from each other. Inevitably, the second printing unit cannot print data on that region of the paper which lies between its printing-start position and the printing-start position of the first printing unit.

Here arises a problem. The first and second printing units have a platen roller each. Therefore, the distance between the printing-start position of the first printing unit and that of the second printing unit cannot be shorter than the diameter of the platen rollers. A region of the paper, which cannot be printed by the second printing unit, is inevitably large. (Hereinafter, this region will be referred to as “unprintable region.”) That is, a large part of the thermal paper is wasted.

If the diameter of the platen roller of the second printing unit is reduced, the distance between the printing-start position of the first printing unit and that of the second printing unit can be indeed decreased. In this case, however, the nip between the platen roller and thermal head of each printing unit cannot be wide enough to accomplish high-quality printing.

### BRIEF SUMMARY OF THE INVENTION

An object of the present invention is to provide a printer in which the printer heads are prevented from interfering with any other components when the cover is closed.

Another object of the present invention is to provide a thermal printer that can use not only double-sided thermal papers and single-sided thermal papers, but also thermal papers having timing marks.

A still another object of the present invention is to provide a printer in which the distance between the printing-start position of the first printing unit and that of the second printing unit can be reduced, without impairing the printing performance of the second printing unit.

To achieve these objects, a printer according to an aspect of the invention comprises: a main unit which is configured to hold a rolled paper; a cover which covers the main unit; a hinge mechanism which is located between the main unit and the cover and which supports the cover, allowing the cover to rotate between a first state in which the cover is opened with respect to the main unit and the rolled paper is therefore able to be set in and removed from the main unit, and a second state in which the cover is closed with respect to the main unit; a first print head which is provided in the cover to print data on a first side of the rolled paper; and a second print head which is provided in the main unit to print data on a second side of the rolled paper. The first print head and the second print head are able to rotate along a rotation locus of the cover.

To attain the objects described above, a thermal printer according another aspect of this invention is designed to print data on a thermal paper having a thermosensible layer on at least one side. This printer comprises: a first thermal head which is arranged to contact the one side of the thermal paper and to print data on the one side of the thermal paper; a first platen roller which is opposed to the first thermal head across the thermal paper; a cutter mechanism which is arranged downstream with respect to the first thermal head, in a direction of feeding the thermal paper, and which is configured to cut the thermal paper; a second thermal head which is arranged upstream with respect to the first thermal head, in the direction of feeding the thermal paper, to contact the another side of the thermal paper; a second platen roller which is opposed to the second thermal head across the thermal paper; a motor; a drive-force transmitting mechanism which is configured to transmit rotation of the motor to the first platen roller and the second platen roller; a first paper sensor which is arranged upstream with respect to the second thermal head, in the direction of feeding the thermal paper and which is configured to detect the thermal paper; and a second paper sensor which is arranged between the first thermal head and the second thermal head and which is configured to detect a distal end of the thermal paper and to read optically marks printed on the thermal paper.

To achieve the objects described above, a printer according to still another aspect of this invention has a first print head and a first platen that are opposed to a second print head and a second platen, respectively, across a paper-feeding path. Data is printed on both sides of a paper at the same time. In this printer, the first platen is a platen roller which rotates to feed the paper, and the second platen is fixed in place, has an arced surface opposed to the second print head and having a radius of curvature almost equal to a radius of curvature of the first platen, and has a width as measured in the direction of feeding the paper, which is smaller than a diameter of the first platen.

In the present invention, the first print head and the second print head can rotate along the locus of the cover. The first print head and the second print head can therefore be prevented from interfering with the any other components provided in the main unit when the cover is opened or closed.

Further, in this invention, the second paper sensor can detect the distal end of the thermal paper and can timing marks such as black dots. The timing marks may be beforehand printed on a single-sided thermal paper. They may be printed a double-sided thermal paper, by using the second thermal head. The thermal printer according to this invention can use both a double-sided thermal paper and a single-sided thermal paper. In addition, the thermal printer can use thermal papers having timing marks. Thus, the thermal print has high versatility Moreover, the present invention can reduce the unprintable region of a paper, without impairing the printing performance, and can therefore avoid wasting of paper.

### BRIEF DESCRIPTION OF THE SEVERAL VIEWS OF THE DRAWING

FIG. 1 is a side view of a thermal printer according to a first embodiment, schematically showing the second state in which the cover is closed;

FIG. 2 is a side view of the thermal printer of FIG. 1, schematically showing the first state in which the cover is opened;

FIG. 3 is a sectional view of the thermal printer according to a second embodiment, showing the second state in which the cover is closed;

FIG. 4 is a sectional view of the thermal printer of FIG. 3, showing the first state in which the cover is opened;

FIG. 5 is a magnified sectional view of the thermal printer of FIG. 3, showing the major components of the thermal printer;

FIG. 6 is a sectional view of the thermal printer of FIG. 5, illustrating how the first thermal head is moved;

FIG. 7 is a sectional view of the thermal printer of FIG. 5, illustrating how the second thermal head is moved;

FIG. 8 is a side view of a thermal printer according to a third embodiment, schematically showing the internal structure of the thermal printer;

FIG. 9 is a sectional view of a double-sided thermal paper;

FIG. 10 is a perspective view showing a part of a thermal paper having timing marks;

FIG. 11 is a schematic diagram showing a printer that is a fourth embodiment of the present invention;

FIG. 12 is a diagram showing a paper, explaining how data is printed on one side by the printer of FIG. 11;

FIG. 13 is a diagram the paper, explaining how data is printed on the other side by the printer of FIG. 11; and

FIG. 14 is a schematic diagram showing a printer that is a fifth embodiment of the present invention.

### DETAILED DESCRIPTION OF THE INVENTION

Embodiments of the present invention will be described in detail, with reference to the accompanying drawings. Here, the embodiments are mechanisms, each using thermal heads.

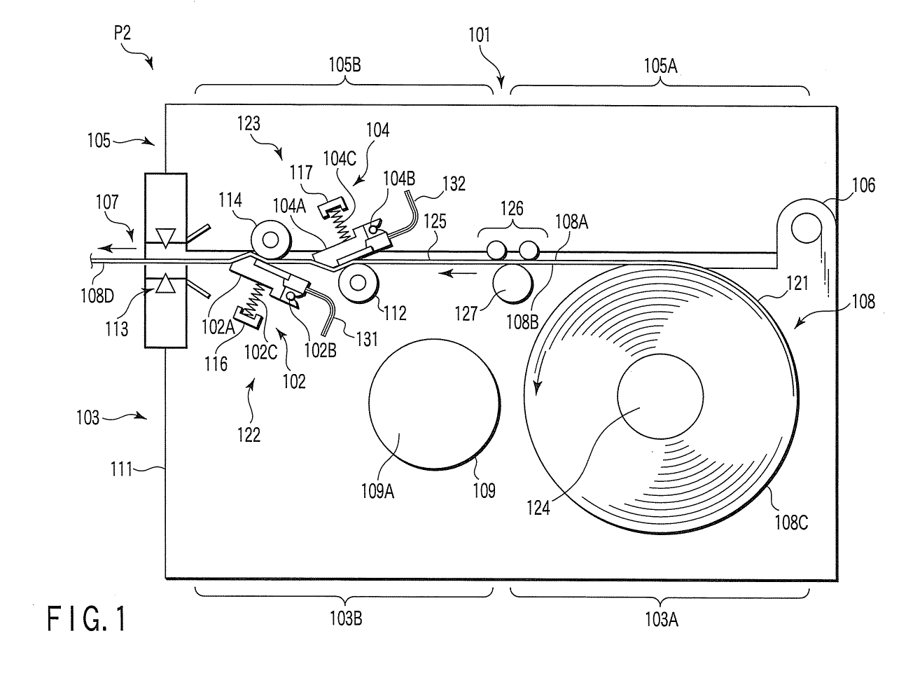

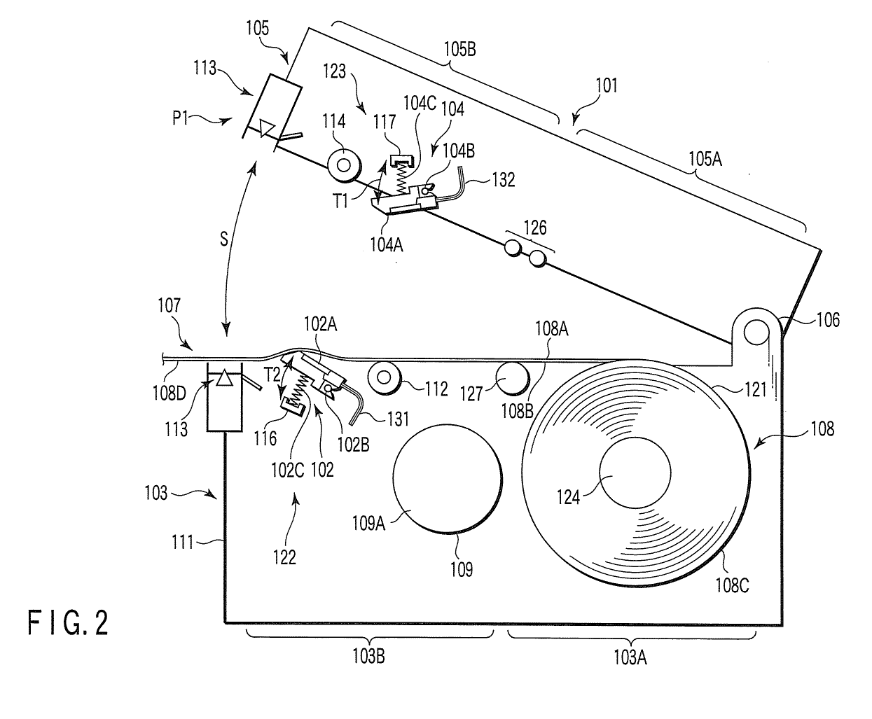

A printer according to the first embodiment will be described, with reference to FIGS. 1 and 2. As FIG. 1 shows, the thermal printer 101, which is one type of a printer, comprises a main unit 103, a cover 105, a hinge mechanism 106, and a paper-ejecting unit 107. The main unit 103 has a second thermal head 102 that is a print head. The cover 105 has a first thermal head 104, i.e., print head, and covers the main unit 103. The hinge mechanism 106 is positioned between the main unit 103 and the cover 105. The paper-ejecting unit 107 is opposed to the hinge mechanism 106 and located between the main unit 103 and the cover 105. The hinge mechanism 106 supports the cover 105, allowing the same to rotate. That is, the cover 105 can be rotated between a first state P1 and a second state P2, in which it is opened and closed, respectively, with respect to the main unit 103.

The thermal printer 101 further comprises a second printing unit 122, and a first printing unit 123 arranged between the second printing unit 122 and the thermal paper supplying unit 121.

The first printing unit 123 has the first thermal head 104, a first platen roller 112, and a first harness 132. The first thermal head 104 is arranged to print data on the first side 108A of the rolled paper 108 being fed through a paper-feeding path 125. The first platen roller 112 is opposed to the first thermal head 104 across the paper-feeding path 125. The first harness 132 is secured to the first thermal head 104. The first thermal head 104 is arranged such that the first harness 132 projects away from the paper-feeding path 125.

The second printing unit 122 has the second thermal head 102, a second platen 114, and a second harness 131. The second thermal head 102 is arranged to print data on the second side 108B of the rolled paper 108 being fed through a paper-feeding path 125. The second platen roller 114 is opposed to the second thermal head 102 across the paper-feeding path 125. The second harness 131 is secured to the second thermal head 102. The second thermal head 102 is arranged such that the second harness 131 projects away from the paper-feeding path 125.

The paper-ejecting unit 107 has an ejection port that is provided between the main unit 103 and the cover 105. The paper-ejecting unit 107 can ejects outside a part of the rolled paper 108, which has been printed by the first thermal head 104 and the second thermal head 102.

As shown in FIGS. 1 and 2, the main unit 103 comprises a housing 111, the second thermal head 102, the first platen roller 112, a part of a cutter mechanism 113. The housing 111 contains the rolled paper 108. The second thermal head 102 is designed to print data on the rolled paper 108. The first platen roller 112 is provided in the main unit 103, is opposed to the first thermal head 104 provided in the cover 105 and can be rotated. The part of a cutter mechanism 113 is located downstream with respect to the first platen roller 112. The rolled paper 108 is a so-called double-sided thermal paper. The rolled paper 108 has a first side 108A and a second side 108B that is opposite to the first side 108A. The rolled paper 108 is contained in the thermal paper supplying unit 121, i.e., a recess provided in the housing 111. The rolled paper 108 can be rotated in the supplying unit 121. The second thermal head 102 can print data on the second side 108B of the rolled paper 108.

The supplying unit 121 has a holding section 124 and a feed mechanism 126. The holding unit 124 holds a paper roll 108C. The feed mechanism 126 is configured to feed the rolled paper 108 from the paper roll 108C along the paper-feeding path 125 and has a damper 127. The damper 127 has the function of applying a predetermined tension on the rolled paper 108.

The first platen roller 112 is supported at both ends by, for example, the housing 111 and can be rotated. The second thermal head 102 is arranged downstream with respect to the first platen roller 112, in the direction of feeding the rolled paper 108. The main unit 103 further comprises a drive section 109 that achieves the feeding of the rolled paper 108. The drive section 109 has a stepping motor 109A and a plurality of reduction gears. The stepping motor 109A generates a rotational force. The reduction gears transmit the rotational force to some of the components of the thermal printer 101. The reduction gears are not shown.

The main unit 103 includes a first main unit half 103A and a second main unit half 103B. The hinge mechanism 106 is secured to the first main unit half 103A. The paper-ejecting unit 107 is secured to the second main unit half 103B and located remote from the first main unit half 103A. The second thermal head 102 is arranged in the second 103B of the main unit 103. The rolled paper 108 is contained in the first main unit half 103A of the main body 103. The rolled paper 108 has the paper roll 108C and an end part 108D fed from the paper roll 108C. That is, the rolled paper 108 is attached to the main unit 103, with the end part 108D fed from the paper roll 108C. The end part 108D overlaps, in part, the paper-ejecting unit 107.

The cover 105 comprises an upper frame (not shown), the first thermal head 104, the second platen roller 114, and a part of the cutter mechanism 113. The first thermal head 104 is provided to print data on the first side 108A of the rolled paper 108. The upper frame holds the second platen roller 114 in such a manner that the platen roller 114 corresponds in position to the second thermal head 102, and allows the roller 114 to rotate. The upper frame is fastened, at one end, to the hinge mechanism 106. The first thermal head 104 is fastened to the upper frame. The first thermal head 104 is located upstream with respect to the second platen roller 114, in the direction of feeding the rolled paper 108.

As FIG. 1 shows, the cover 105 includes a first cover half 105A and a second cover half 105B. The hinge mechanism 106 is secured to the half 105A. The paper-ejecting unit 107 is secured to the other half 105B and located remote from the half 105A. The first thermal head 104 is arranged in the other half 105B.

As FIG. 1 shows, too, the first thermal head 104 has a first thermal-head main unit 104A, a first shaft 104B, and a first spring 104C. The first shaft 104B supports the first thermal-head main unit 104A, allowing the same to rotate. The first spring 104C is arranged between the first thermal-head main unit 104A and the upper frame. The first shaft 104B is provided on the upper frame. The first spring 104C is arranged and compressed between the first thermal-head main unit 104A and a spring seat 117. The first spring 104C pushes the first thermal-head main unit 104A to the first platen roller 112 at a predetermined pressure. Thus, the rolled paper 108 is clamped between the first thermal-head main unit 104A and the first platen roller 112.

The second thermal head 102 has a second thermal-head main unit 102A, a second shaft 102B, and a second spring 102C. The second shaft 102B supports the second thermal-head main unit 102A, allowing the same to rotate. The second spring 102C is arranged between the second thermal-head main unit 102A and a spring seat 116. The second shaft 102B is provided on the housing 111. The second spring 102C is arranged and compressed between the second thermal-head main unit 102A and the spring seat 116. The second spring 102C pushes the second thermal-head main unit 102A to the second platen roller 114 at a predetermined pressure. Thus, the rolled paper 108 is clamped between the second thermal-head main unit 102A and the second platen roller 114.

How the thermal printer 101 operates to print data will be explained, with reference to FIG. 1. When the stepping motor 109A drives the reduction gears, the first platen roller 112, second platen roller 114 and feed mechanism 126 are rotated. As the rollers 112 and 114 and the mechanism 126 are rotated, the rolled paper 108 is fed toward the paper-ejecting unit 107 in the paper-feeding direction. Thus, the feed mechanism 126 feeds the rolled paper 108 from the holding unit 124 along the paper-feeding path 125. The rolled paper 108, thus fed by the feed mechanism 126 is clamped by the first thermal head 104 and the first platen roller 112. At the same time, the first thermal head 104 prints data on the first side 108A of the rolled paper 108 in accordance a signal input through the first harness 132.

The rolled paper 108 is then fed from the first printing unit 123 to the second printing unit 122 and clamped between the second thermal head 102 and the second platen roller 114. The second thermal head 102 of the second printing unit 122 heats the second thermal head 102 in accordance with a signal input through the second harness 131. Thus, the second thermal head 102 prints data on the second side 108B of the rolled paper 108. Finally, the cutter mechanism 113 cuts the rolled paper 108, forming a paper having a predetermined length. The thermal printer 101 thus completes the printing.

If the distance between the first printing unit 123 and the second printing unit 122 is long, the unprintable region of the paper 108 will expands. Conversely, if this distance is short, the second harness 131 and the first platen roller 112 will more likely interfere with each other. In the thermal printer 101, the first thermal head 104 and the second thermal head 102 are incline at an angle to the paper-feeding path 125. The second harness 131 is therefore shifted to the left in FIG. 1 and the first platen roller 112 is shifted to the right in FIG. 1, in the direction the feeding path 125 extends. As a result, the distance between the second thermal head 102 and the first platen roller 112 can be shortened.

The distance between the first printing unit 123 and the second printing unit 122 can thus be shortened. Therefore, the unprintable region can be minimized.

Since the unprintable region is narrowed, the distance the unprintable region is fed decreases. This helps to raise the printing speed.

According to the present invention, the first platen roller 112 and the second harness 131 can be prevented from interfering with each other even if the distance between the two thermal heads is shortened in order to minimize the unprintable region.

How the first thermal head 104 and the second thermal head 102 operate when the cover 105 is opened or closed with respect to the main unit 103 will be explained with reference to FIGS. 1 and 2. To change the state of the thermal printer 101 from the first state P1 shown in FIG. 2 to the second state P2 shown in FIG. 1, the cover 105 is rotated around the hinge mechanism 106.

As the cover 105 is rotated to the closed position, the first thermal head 104 provided in the cover 105 is pushed with a prescribed force onto the first platen roller 112. More specifically, the first shaft 104B of the first thermal head 104 moves downwards. As the first shaft 104B moves so, the first thermal-head main unit 104A moves in contact with the first platen roller 112 and, at the same time, rotates in direction T1, or along the rotation locus S of the cover 105. The first spring 104C is thereby compressed because it is located between the spring seat 117 and the first thermal-head main unit 104A. The reaction of the spring 104C presses the first thermal-head main unit 104A onto the first platen roller 112 with a predetermined pressure, clamping the rolled paper 108 jointly with the first platen roller 112.

Similarly, the second platen roller 114 provided in the cover 105 is pushed onto the second thermal head 102 of the main unit 103 as the cover 105 is rotated. As the second platen roller 114 moves so, the second thermal head 102 rotates around the second shaft 102B, in direction T2, or along the rotation locus S of the cover 105. The second spring 102C is thereby compressed between the second thermal-head main unit 102A and the spring seat 116 of the main unit 103. The reaction of the second spring 102C presses the second thermal-head main unit 102A onto the second platen roller 114 with a predetermined pressure, clamping the rolled paper 108 jointly with the second platen roller 114.

Thus far described is the thermal printer 101 according to the present embodiment. In the thermal printer 101 according to the present embodiment, the first thermal head 104 and the second thermal head 102 can be rotated in directions T1 and T2, respectively, or along the rotation locus S of the cover 105. Hence, neither the motion of the first thermal head 104 nor the motion of the second thermal head 102 interfere with the cover 105 when the cover 105 is opened or closed with respect to the main unit 103. The first thermal head 104 and the second thermal head 102 are therefore prevented from colliding with any other components of the thermal printer 101. Thus, the other components can be protected from damages. Further, the cover 105 can be smoothly opened and closed. Still further, since the first thermal head 104 and the second thermal head 102 can be rotated in directions T1 and T2, or along the rotation locus S of the cover 105, their installation space can be small. The thermal printer 101 can therefore be small.

In present embodiment, the paper-ejecting unit 107 is arranged between the main unit 103 and the cover 105 and located remote from the hinge mechanism 106. Since the paper-ejecting unit 107 is arranged on the side opposite to the side where the hinge mechanism 106 is provided, an access to the paper-ejecting unit 107 can be easy. Therefore, to place the rolled paper 108 in the main unit 103, it suffices to set the paper roll 108C in the first half 103A of the main body 103 and to lay the end part 108D of the paper 108 on the paper-ejecting unit 107. Thus, the rolled paper 108 can be easily placed in the main unit 103.

In this embodiment, the first thermal head 104 is arranged in the half 105B of the cover 105, in which the paper-ejecting unit 107 is arranged. Therefore, the first thermal head 104 can be positioned near the paper-ejecting unit 107. This helps to render the thermal printer 101 small.

In this embodiment, the second thermal head 102 is arranged in the half 103B of the main unit 103, in which the paper-ejecting unit 107 is arranged. Therefore, the second thermal head 102 can be positioned near the first thermal head 104 and the paper-ejecting unit 107. Thus, the first thermal head 104 and the second thermal head 102 can be arranged in the vicinity of the paper-ejecting unit 107. This can make the thermal printer 101 small and can prevent the second thermal head 102 from hindering the placing or removal of the rolled paper 108.

The rolled paper 108 is arranged in the first half 103A of the main unit 103, in which the hinge mechanism 106 is provided. The rolled paper 108 can therefore be arranged remote from the paper-ejecting unit 107 at which the first thermal head 104 and the second thermal head 102 are provided. Hence, the first thermal head 104 provided in the cover 105 and the components adjacent to the head 104, such as the second platen roller 114, do not interfere with the rolled paper 108 while the rolled paper 108 is being replaced with a new one. The rolled paper 108 can therefore be smoothly replaced with a new one.

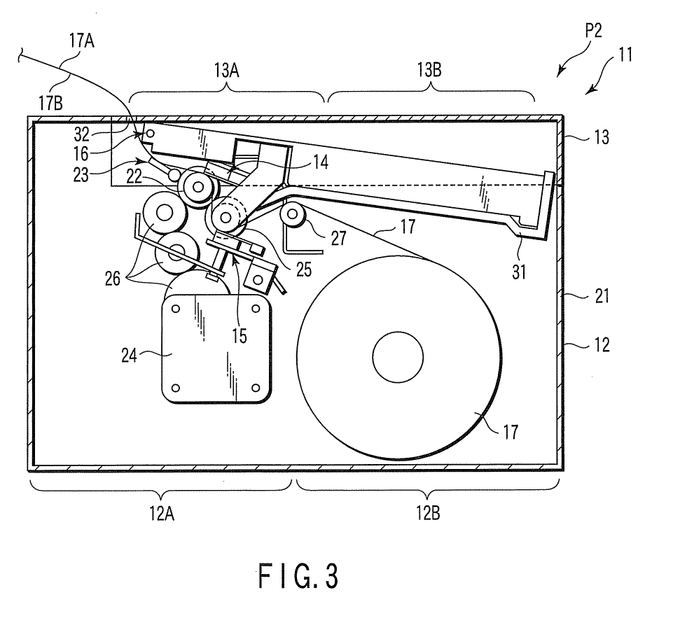

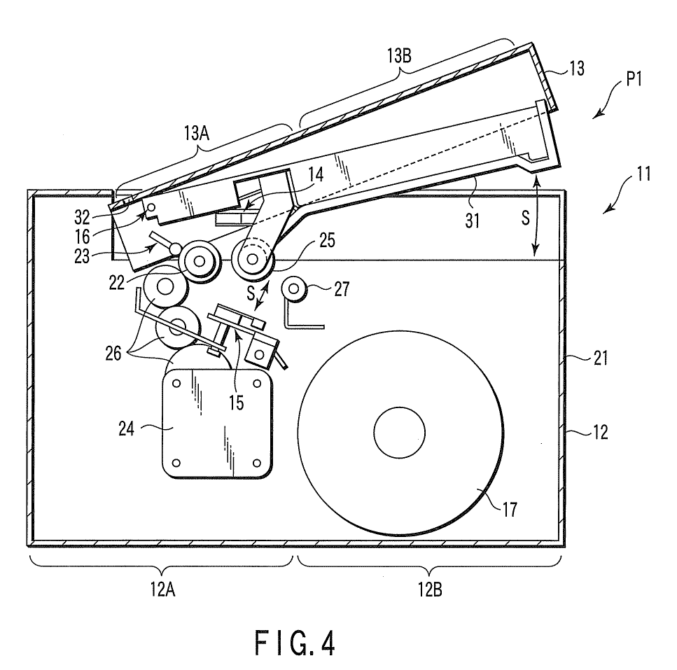

A printer according to the second embodiment of the invention will be described, with reference to FIGS. 3 to 7. As FIG. 3 shows, a thermal printer 11, i.e., printer according to the second embodiment, comprises a main unit 12, a cover 13, and a hinge mechanism 16. The main unit 12 has a second thermal head 15 that is a print head. The cover 13 covers the main unit 12 and has a first thermal head 14 that is a print head. The hinge mechanism 16 is positioned between the main unit 12 and the cover 13. That is, the hinge mechanism 16 enables the cover 13 to rotate between a first state P1 (FIG. 4) and a second state P2 (FIG. 3), in which it is opened and closed, respectively, with respect to the main unit 12.

As shown in FIGS. 3 and 4, the main unit 12 comprises a housing 21, the second thermal head 15, the first platen roller 22, a cutter mechanism 23. The housing 21 contains a rolled paper 17. The second thermal head 15 is designed to print data on the rolled paper 17. The first platen roller 22 is provided in the main unit 12, is opposed to the first thermal head 14 provided in the cover 13 and can be rotated. The part of a cutter mechanism 23 is located downstream with respect to the first platen roller 22. The rolled paper 7 is a so-called double-sided thermal paper. The rolled paper 17 has a first side 17A and a second side 17B that is opposite to the first side 17A. The rolled paper 17 is contained in a recess (not shown) provided in the housing 21 and can be rotated. The second thermal head 15 can print data on the second side 17B of the rolled paper 17.

The first platen roller 22 is supported at both ends by, for example, the housing 21 and can be rotated. The second thermal head 15 is arranged upstream with respect to the first platen roller 22, in the direction of feeding the rolled paper 17. The main unit 12 further comprises a drive section 24, a plurality of reduction gears 26, and a guide roller 27. The drive section 24 achieves the feeding of the rolled paper 17. The reduction gears 26 transmit a drive force from the drive section 24 to the first platen roller 22 and the second platen roller 25. The guide roller 27 is located upstream with respect to the second thermal head 15. The drive section 24 is constituted by, for example, a stepping motor.

The main unit 12 includes a first main unit half 12A and a second main unit half 12B. The hinge mechanism 16 is secured to the first half 12A. The second half 12B lies besides the first half 12A. The second thermal head 15 is arranged in the first half 12A of the main unit 12. The rolled paper 17 is attached to the second half 12B of the main unit 12.

The cover 13 comprises an upper frame 31, the first thermal head 14, the second platen roller 25, and an ejection port 32. The first thermal head 14 is provided to print data on the first side 17A of the rolled paper 17. The second platen roller 25 is supported by the upper frame 31 in such a manner as to correspond in position to the second thermal head 15, and can be rotated. Through the ejection port 32, the rolled paper 17 can be ejected outside. The upper frame 31 is secured at one end to the hinge mechanism 16. The first thermal head 14 is attached to the upper frame 31. The second platen roller 25 is supported at both ends by the upper frame 31. The first thermal head 14 is arranged downstream with respect to the second platen roller 25, in the direction of feeding the rolled paper 17.

As FIG. 3 shows, the cover 13 includes a first cover half 13A and a second cover half 13B. The hinge mechanism 16 is secured to the half 13A. The other half 13B lies besides the half 13A. The first thermal head 14 is arranged in the half 13A of the cover 13.

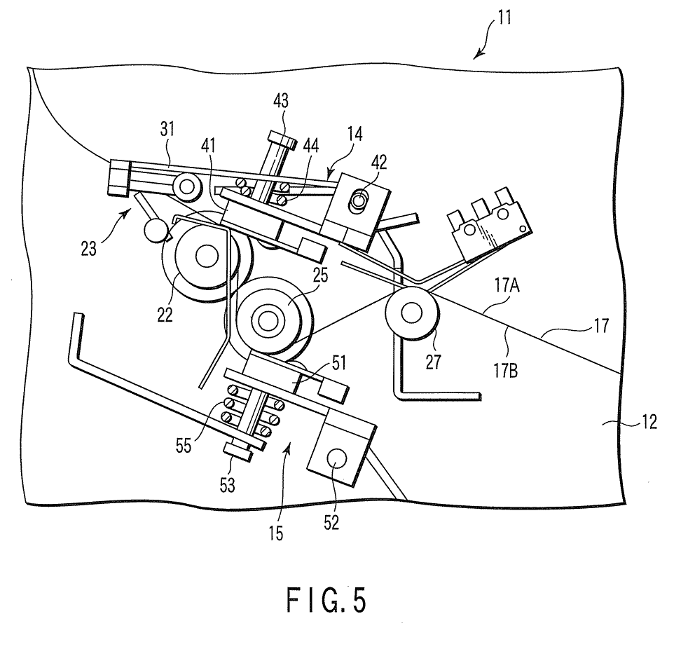

As FIG. 5 shows, the first thermal head 14 has a first thermal-head main unit 41, a first shaft 42, a first adjustment screw 43, and a first spring 44. The first shaft 42 supports the first thermal-head main unit 41, allowing the same to rotate around it. The first adjustment screw 43 is secured to the first thermal head 41. The first spring 44 is arranged between the first thermal-head main unit 41 and the upper frame 31. The first shaft 42 is secured to the upper frame 31. The first thermal-head main unit 41 is pushed onto the first platen roller 22 by the first spring 44 at a predetermined pressure, clamping the rolled paper 17 jointly with the first platen roller 22. The angle through which the first thermal-head main unit 41 can rotate can be adjusted by turning the first adjustment screw 43.

The second thermal head 15 has a second thermal-head main unit 51, a second shaft 52, a second adjustment screw 53, and a second spring 55. The second shaft 52 supports the second thermal-head main unit 51, allowing the same to rotate around it. The second adjustment screw 53 is secured to the second thermal head 51. The second spring 55 is arranged between the second thermal-head main unit 51 and the frame 54 of the housing 21. The second shaft 52 is secured to the housing 21. The second thermal-head main unit 51 is pushed onto the second platen roller 25 by the second spring 55 at a predetermined pressure, clamping the rolled paper 17 jointly with the second platen roller 25. The maximum angle through which the second thermal-head main unit 51 can rotate can be adjusted by turning the second adjustment screw 53.

How the thermal printer 11 operates to print data will be explained, with reference to FIG. 3. When the reduction gears 26 are driven, the first platen roller 22 and the second platen roller 25 rotate. As these rollers rotate, the rolled paper 17 is fed toward the ejection port 32, in the paper-feeding direction. The second thermal head 15 prints data on the second side 17B of the rolled paper 17. The first thermal head 14 then prints data on the first side 17A of the rolled paper 17. Finally, the cutter mechanism 23 cuts the rolled paper 17, forming a paper slip having a predetermine length. The thermal printer 11 thus completes the printing.

How the first thermal head 14 and the second thermal head 15 operate when the cover 13 is opened or closed with respect to the main unit 12 will be explained with reference to FIGS. 3 to 6. To change the state of the thermal printer 11 from the first state P1 shown in FIG. 4 to the second state P2 shown in FIG. 3, the cover 13 is rotated around the hinge mechanism 16.

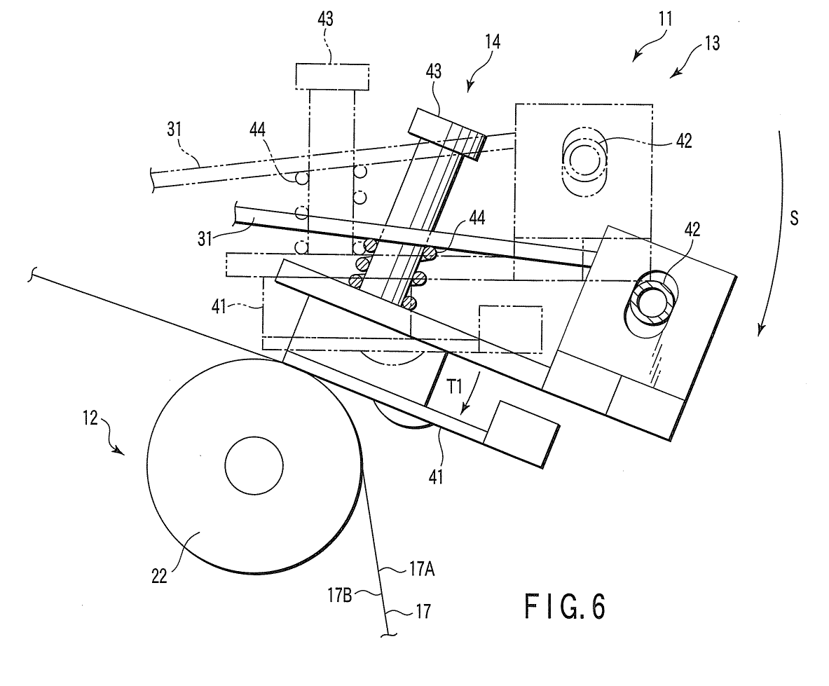

As the cover 13 is rotated to the closed position, the first thermal head 14 provided in the cover 13 is pushed with a prescribed force onto the first platen roller 22, as illustrated in FIG. 6. More specifically, the first shaft 42 of the first thermal head 14 moves downwards. As the first shaft 42 so moves, the first thermal-head main unit 41 moves in contact with the first platen roller 22 and rotates in direction T1, or along the rotation locus S of the cover 13. The first spring 44, which is provided between the upper frame 31 and the first thermal-head main unit 41, is thereby compressed. The reaction of the spring 44 presses the first thermal-head main unit 41 onto the first platen roller 22 with a predetermined pressure, clamping the rolled paper 17 jointly with the first platen roller 22.

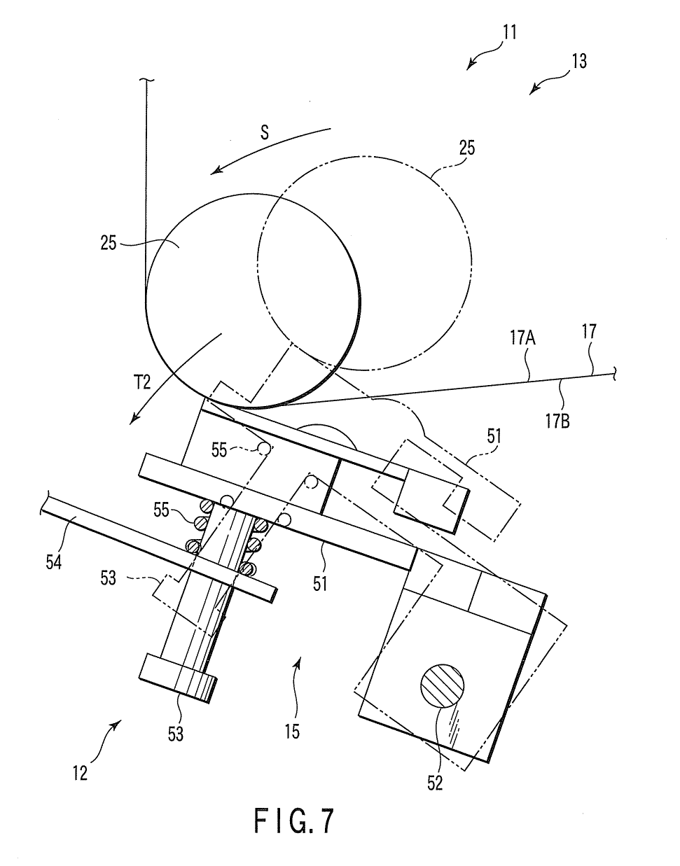

Similarly, the second platen roller 25 provided in the cover 13 is pushed onto the second thermal head 15 provided in the main unit 12 as the cover 13 is rotated, as illustrated in FIG. 7. As the second platen roller 25 moves so, the second thermal head 15 rotates in direction T2, or along the rotation locus S of the cover 13. At the same time, the second spring 55 is compressed between the second thermal-head main unit 51 and the frame 54 of the main unit 12. The reaction of the second spring 55 presses the second thermal-head main unit 51 onto the second platen roller 25 with a predetermined pressure, clamping the rolled paper 17 jointly with the second platen roller 25.

Thus far described is the thermal printer 11 according to the present embodiment. In the thermal printer 11 according to the present embodiment, the first thermal head 14 and the second thermal head 15 can be rotated in directions T1 and T2, respectively, or along the rotation locus S of the cover 13. Hence, neither the motion of the first thermal head 14 nor the motion of the second thermal head 15 interfere with the cover 13 when the cover 13 is opened or closed with respect to the main unit 12. The first thermal head 14 and the second thermal head 15 are therefore prevented from colliding with any other components of the thermal printer 11. Thus, the other components can be protected from damages. Further, the cover 13 can be smoothly opened and closed. Still further, since the first thermal head 14 and the second thermal head 15 can be rotated in directions T1 and T2, or along the rotation locus S of the cover 13, their installation space can be small. The thermal printer 11 can therefore be small.

The first thermal head 14 is arranged in the half 13A of the cover 13, in which the hinge mechanism 16 is fixed and secured. Thus, the first thermal head 14 can be arranged in the vicinity of the hinge mechanism 16. This can make the thermal printer 11 small. If the first thermal head 14 is arranged near the hinge mechanism 16, it will not project outside when the cover 13 is opened. Hence, the first thermal head 14 does not hinder the replacing the rolled paper 17 with a new one.

The second thermal head 15 is arranged in the first half 12A of the main unit 12, in which hinge mechanism 16 is secured. Therefore, the second thermal head 15 can be arranged near the first thermal head 14 and the hinge mechanism 16. The first thermal head 14 and the second thermal head 15 are thereby located close to each other. This helps to render the thermal printer 11 small. Further, this can prevent the second thermal head 15 from hindering the placing or removal of the rolled paper 17.

The rolled paper 17 is arranged in the second half 12B of the main unit 12, in which the hinge mechanism 16 is provided. The rolled paper 17 can therefore be arranged remote from the hinge mechanism 16 at which the first thermal head 14 and the second thermal head 15 are provided. Thus, the cover 13 in the opened position, the first thermal head 14 provided in the cover 13 and the components adjacent to the head 14, such as the second platen roller 25, do not interfere with the rolled paper 17 while the rolled paper 17 is being replaced with a new one. The rolled paper 17 can therefore be smoothly replaced with a new one.

Both printers according to the first and second embodiments are thermal printers. Nevertheless, the present invention can be applied to other types of recording systems. For example, the first head 104 or 14 can be, of course, replaced by a first ink-jet head, and the second thermal head 102 or 15 may be replaced by a second ink-jet head. If this is the case, the ink-jet heads should be spaced from a printing paper by a prescribed distance, not in direct contact therewith as thermal print heads. To space the ink-jet heads from the paper, a spacer, such as a roller, must be provided. Then, the present invention can provide ink-jet printers.

Thermal printers according to this invention are not limited to the embodiments described above. In the embodiments described above, the rolled paper is a double-sided thermal paper. The rolled paper may be an ordinary paper. In this case, an ink ribbon may be used to print data on both sides of the rolled paper. Moreover, various changes and modifications can be made, without departing from the scope and spirit of the present invention.

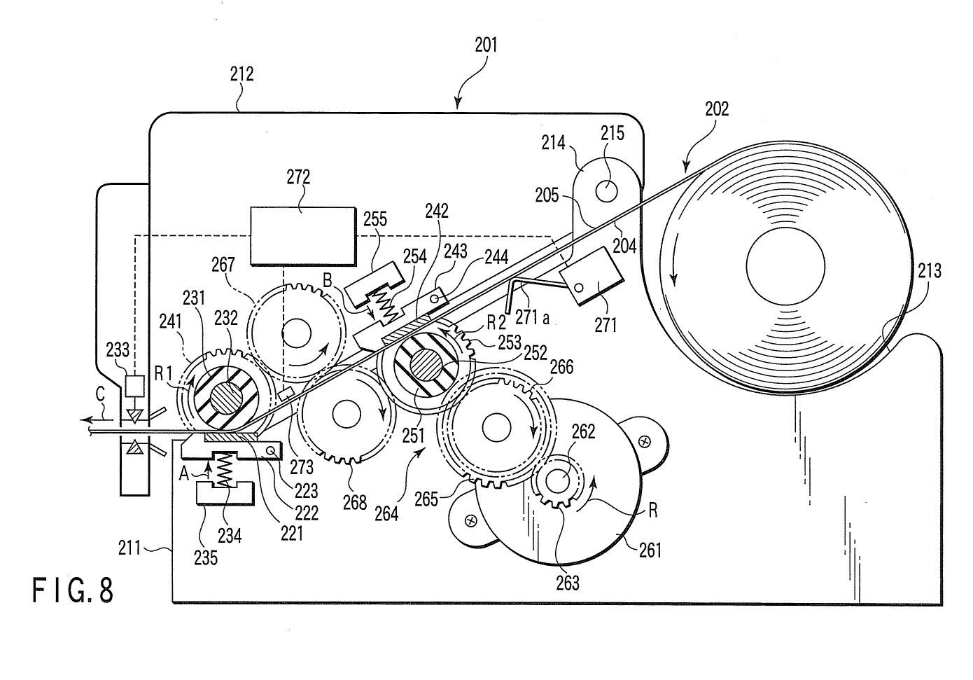

A thermal printer according to the third embodiment of this invention will be described, with reference to FIGS. 8 to 10.

FIG. 8 schematically shows the internal structure of a thermal printer 201 according to the third embodiment. This thermal printer 201 can simultaneously print data on both sides of a double-sided thermal paper 302. The printer 201 can be used in, for example, cash registers for use in retail shops.

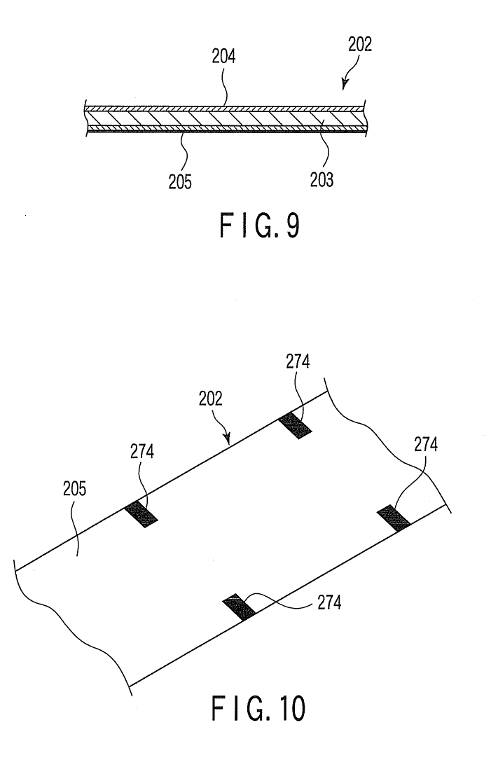

As shown in FIG. 9, the double-sided thermal paper 202 (hereinafter called “thermal paper”) has a base paper 203 and two thermosensible layers 204 and 205. The layers 204 and 205 are formed on the obverse and reverse sides of the base paper 203, respectively. More precisely, the first thermosensible layer 204 is formed on one side (e.g., obverse side) of the base paper 203, and the second thermosensible layer 205 is formed on other side (e.g., reverse side) of the base paper 203. These layers 204 and 205 are made of material that attains a desired color, such as black or red, when it is heated to a temperature equal to or higher than a predetermined value. As FIG. 8 shows, the thermal paper 202 is rolled, forming a roll, with the first thermosensible layer 204 turned inwards.

The thermal printer 201 has a printer main unit 211 and a cover 212. The cover 121 can be opened and closed. The printer main unit 211 has a paper receptacle 213, in which the rolled thermal paper 202 is placed. The cover 212 can be rotated up and down, around the shaft 215 of a hinge unit 214 provided on the printer main unit 211. When the cover 212 opened, the printer main unit 211 is opened at the top. FIG. 8 shows the cover 212 in the closed state.

A first thermal head 221 is provided in the printer main unit 211. The first thermal head 221 is arranged in the printer main unit 211 an can contact one side of the thermal paper 202, more precisely the first thermosensible layer 204. The first thermal head 221 is secured to a heat sink 222 that is a heat-radiating member. The first thermal head 221 and the heat sink 222 can rotate around a shaft 223.

In the cover 212, a first platen roller 231 is arranged and opposed to the first thermal head 221. The first platen roller 231 faces the first thermal head 221, clamping the thermal paper 202 jointly with the first thermal head 221, while the cover 212 remains closed as shown in FIG. 8.

The first platen roller 231 is made of elastic material having a coefficient of friction greater than that of metal, such as nitrilebutadiene rubber (NBR). The first platen roller 231 is shaped like a circular column and can rotate together with a first platen shaft 232 that extend in horizontal direction. A cutter mechanism 233 is located downstream with respect to the first thermal head 221 in the direction of feeding the thermal paper. The cutter mechanism 233 is used to cut the thermal paper 202. The cutter mechanism 233 is provided in, for example, the cover 212.

As FIG. 8 shows, the first thermal head 221 is set in a horizontal position, below the first platen roller 231. The distal-end part of the thermal paper 202 rolled and contained in the paper receptacle 213 passes through the nip between the first thermal head 221 and the first platen roller 231 and then through the cutter mechanism 233 and is ejected in the direction of arrow C shown in FIG. 8.

At the back of the first thermal head 221, a first biasing means 234 is provided. An example of the first biasing means 234 is a spring member such as a compression spring or a torsion spring. The first biasing means 234 is arranged between the heat sink 222 and a spring seat 235 that is provided in the printer main unit 211. The first biasing means 234 pushes the first thermal head 221 toward the first platen roller 231 in the direction of arrow A shown in FIG. 8.

A first platen gear 241 is mounted on the first platen shaft 232. The first platen gear 241 rotates together with the first platen roller 231. The first platen shaft 232 is supported by a bearing (not shown) provided in the cover 212 and can rotate.

A second thermal head 242 is provided in the cover 212. The second thermal head 242 is arranged upstream with respect to the first thermal head 221, in the direction of feeding the thermal paper 202. The second thermal head 242 is arranged in the cover 212 to contact the other side of the thermal paper 202, i.e., the second thermosensible layer 205. The second thermal head 242 is secured to a heat sink 243 that is a heat-radiating member. The second thermal head 242 can rotate around a shaft 244.

A second platen roller 251 is provided in the printer main unit 211 and is opposed to the second thermal head 242. The second platen roller 251 faces the second thermal head 242, clamping the thermal paper 202 jointly with the second thermal head 242, while the cover 212 remains closed as is illustrated in FIG. 8.

As FIG. 8 shows, the second thermal head 242 is arranged above the second platen roller 251 and inclined downward. The distal end part of the thermal paper 202, which is rolled and contained in the paper receptacle 213, passes through the nip between the second thermal head 242 and the second platen roller 251 and is fed toward the first thermal head 221.

The second platen roller 251 is made of elastic material having a coefficient of friction greater than that of metal, such as NBR. The second platen roller 251 is shaped like a circular column and is mounted on a second platen shaft 252 that extend in horizontal direction. A second platen gear 253 is mounted on the second platen shaft 252. The second platen gear 253 rotates together with the second platen roller 251. The second platen shaft 252 is supported by a pair of bearings (not shown), i.e., left and right bearings provided in the printer main unit 211. The second platen shaft 252 can therefore rotate.

At the back of the second thermal head 242, a second biasing means 254 is provided. An example of the second biasing means 254 is a spring member such as a compression spring or a torsion spring. The second biasing means 254 is arranged between the heat sink 243 and a spring seat 255 that is provided in the cover 212. The second biasing means 254 pushes the second thermal head 242 toward the second platen roller 251 in the direction of arrow B shown in FIG. 8.

The printer main unit 211 incorporates a motor 261. An example of the motor 261 is a pulse motor that can rotate in both the forward direction and reverse direction. The angle through which it rotates (i.e., rotation angle) can be accurately controlled in accordance with the number of pulses output from a controller 272, which will be described later.

An output gear 263 is mounted on the shaft 262 of the motor 261. The rotation of the shaft 262 of the motor 261 (hence, the rotation of the output gear 263) is transmitted via a drive-force transmitting mechanism 264 to the first platen roller 231 and the second platen roller 251. The drive-force transmitting mechanism 264 includes a reduction gear 265, a drive gear 266, the above-mentioned second platen gear 253, a pair of idler gears 267 and 268, and the above-mentioned first platen gear 241. The reduction gear 265 is set in mesh with the output gear 263. The drive gear 266 rotates together with the reduction gear 265. The second platen gear 253 is set in mesh with the drive gear 266. The first platen gear 241 is set in mesh with the idler gear 267.

One idler gear 267 is arranged in the cover 212, and the other idler gear 268 is arranged in the printer main unit 211. The idler gears 267 and 268 mesh with each other as long as the cover 212 remains closed. When the cover 212 is opened, the idler gears 267 and 268 are disengaged from each other. One idler gears 267 meshes with the first platen gear 241 at all times. The other gear 268 meshes with the second platen gear 253 at all times.

A first paper sensor 271 is arranged upstream with respect to the second thermal head 242, in the direction of feeding the thermal paper 202, in order to detect the thermal paper 202. The first paper sensor 271 is electrically connected to the controller 272. The controller 272 is an example of a control unit that uses a microprocessor or the like.

While the thermal paper 202 remains between the paper receptacle 213 and the second thermal paper 242, the sensing unit 171a of the first paper sensor 271 may contact the thermal paper 202 from below. In this case, the first paper sensor 271 detects the thermal paper 202. When the first paper sensor 271 detects the thermal paper 202, it outputs a signal indicating that the thermal paper 202 has been detected. The signal is supplied to the controller 272.

A second paper sensor 273 is arranged between the first thermal head 221 and the second thermal head 242. The second paper sensor 273 is a reflection-type sensor that can optically detects the distal end of the thermal paper 202 and comprises a light-emitting element and a light-receiving element. The second paper sensor 273 can detect timing marks 274 (see FIG. 10) that are printed on the thermal paper 202. When the second paper sensor 273 detects the distal end of the thermal paper 202, it generates a signal indicating that the distal end has been detected. This signal is supplied to the controller 272.

The timing marks 274 are marks that can be optically read. An example of a timing mark 274 is a black mark (e.g., black dot) that indicates the position where the thermal paper 202 should be cut.

As described above, the thermal paper 202 is a double-sided thermal paper and has two thermosensible layers 204 and 205 on the obverse and reverse sides, respectively. Therefore, the first thermal head 221 can print the timing marks 274 on the first thermosensible layer 204, or the second thermal head 242 can print the marks 274 on the second thermosensible layer 205. To enable the second paper sensor 273 to detect the timing marks 274, however, the second thermal head 242 prints the timing marks 274. This is because the second thermal head 242 is arranged upstream with respect to the sensor 273 in the direction of feeding the thermal paper 202.

The thermal paper 202 may be replaced by a single-sided thermal paper having only one thermosensible layer. If this is the case, the timing marks 274 are printed on the reverse side of the thermal paper (i.e., the side on which no thermosensible layers are provided). That is, the second paper sensor 273 of this embodiment can detect the timing marks 274 printed on the double-sided thermal paper 202 and the timing marks printed on a single-sided thermal paper.

To control the position where to cut the thermal paper 202, by using the timing marks 274, the controller 272 outputs pulses to the motor 261 when the timing marks 274, in number that corresponds to the distance for which the paper 202 has been fed. On the bases of the number of pulses received, the motor 261 is driven by a prescribed angle. That part of the thermal paper 202, which is to be cut, therefore reaches the cutter mechanism 233.

How the thermal printer 201 according to this embodiment operates will be explained below.

When the cover 212 is opened to replenish the thermal paper 202, the first platen roller 231 moves away from the first thermal head 221. At the same time, the second thermal head 242 moves away from the second platen roller 251. Further, the one idler gear 267 is disengaged from the other idler gear 268. The top of the printer main unit 211 is therefore opened. As a result, the first thermal head 221 and the second platen roller 251 are fully exposed to the outside.

While the cover 212 remains closed as shown in FIG. 8, the first biasing means 234 keeps pushing the first thermal head 221 toward the first platen roller 231, and the second biasing means 254 keeps pushing the second thermal head 243 toward the second platen roller 251. Moreover, the idler gears 267 and 268 come into mesh with each other.

The thermal paper 202 is set in the paper receptacle 213, and the distal end of the paper 202 is led to the second thermal head 242. Then, the first paper sensor 271 detects the thermal paper 202, and the controller 272 outputs pulses. These pulses drive the motor 261 by the prescribed angle in the direction of arrow R shown in FIG. 8. The second platen roller 251 is thereby rotated in the direction of arrow R2. The thermal paper 202 is therefore fed toward the first thermal head 221.

The rotation of the shaft 262 of the motor 261 is transmitted via the drive-force transmitting mechanism 264 to the first platen roller 231 and the second platen roller 251. The first platen roller 231 and the second platen roller 251 therefore rotate in the direction of arrow R1 and the direction of arrow R2, respectively. While the thermal paper 202 nipped between the second thermal head 242 and the second platen roller 251 is moving toward the first thermal head 221, the second paper sensor 273 detects the thermal paper 202.

When the second paper sensor 273 detects the distal end of the thermal paper 202, the controller 272 outputs pulses. The pulses drive the motor 261 further, by the prescribed angle. Then, the thermal paper 202 is stopped at a preset printing position, with its distal end clamped between the first thermal head 221 and the first platen roller 231.

When the controller 272 outputs a signal to the motor 261, instructing that data be printed, the motor 261 rotates the first platen roller 231 and the second platen roller 251 in the directions of arrows R1 and R2, respectively. At this time, the first thermal head 221 prints data on the first thermosensible layer 204 of the thermal paper 202. At the same time, the second thermal head 242 can print data on the second thermosensible layer 205 of the thermal paper 202. If necessary, the second thermal head 242 can print, on the desired parts of the second thermosensible layer 205, timing marks 274 that indicate the position where the paper 202 should be cut.

After the printing is thus performed, the thermal paper 202 is fed toward the cutter mechanism 233. While the thermal paper 202 is being fed so, the second paper sensor 273 detects the timing marks 274. Thereafter, the paper 202 is further fed in accordance with the number of pulses output from controller 272, until that part of the thermal paper 202, at which the paper 202 is to be cut, reaches the cutter mechanism 233. Then, the cutter mechanism 233 operates, cutting the thermal paper 202.

The thermal printer 201 according to the present embodiment has a paper-reversing function of driving the motor 261 in the reverse direction in order to move the distal end of the thermal paper 202 cut by the cutter mechanism 233, back to a position near the first thermal head 221. Since the paper-reversing function can return the distal end of the paper 202 to a position near the first thermal head 221, the paper 202 can be prevented from having an unprintable region, i.e., blank region. Thus, the thermal paper 202 will not be wasted.

In the thermal printer 201 according to this embodiment, the thermal paper 202 can be cut, without using timing marks 274. If no timing marks 274 are used, the pulses output from the controller 272 drive the motor 261 by the prescribed angle, thereby feeding the paper 202 until the part of the paper 202, which is to be cut, reaches the cutter mechanism 233. Then, the cutter mechanism 233 operates, cutting the thermal paper 202.

Timing marks may be already printed on the reverse side of a single-sided thermal paper (i.e., the side on which no thermosensible layers are provided). In this case, the position at which to cut the paper can be designated if the second paper sensor 273 detects the timing marks printed on the single-sided thermal paper. Thus, the thermal printer 201 according to this embodiment can use not only double-sided thermal papers, but also single-sided thermal papers.

In reducing this invention to practice, the components of the invention, such as the first and second thermal heads, first and second platen rollers, cutter mechanism, drive-force transmitting mechanism, first paper sensor and second paper sensor, can of course be modified as needed. Moreover, the marks printed on the thermal paper are not limited to timing marks. Any other optically readable marks may be printed, instead.

A printer according to the fourth embodiment will be described in detail.

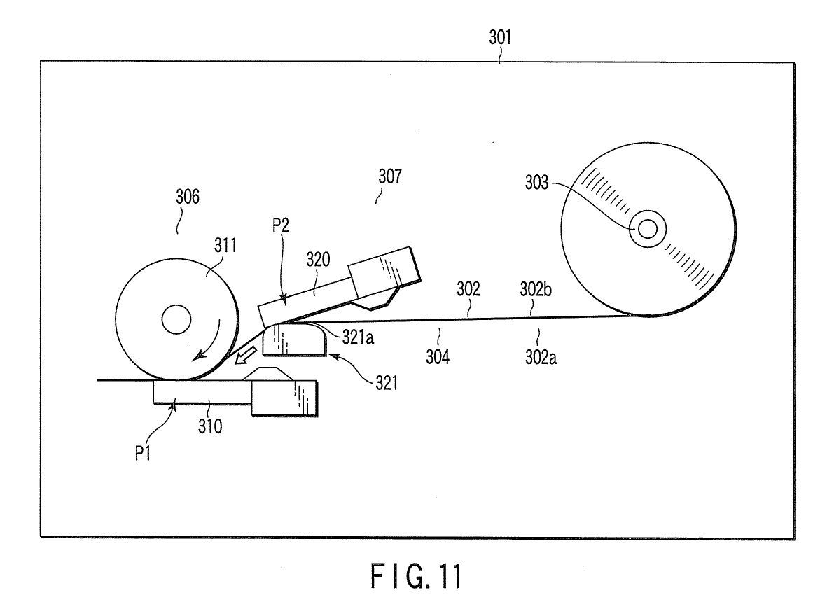

FIG. 11 shows a printer that is the fourth embodiment. In FIG. 11, reference number 301 designates the main unit of the printer. The main unit 301 incorporates a reel unit 303 from which a paper 302 is supplied. One side of the paper 302 is a thermosensible side 302a. The other side of the paper 302 is a thermosensible side 302b. The paper 302 is fed along the paper-feeding path 304. First and second printing units 306 and 307 are arranged in the paper-feeding path 304. The first printing unit 306 is arranged downstream with respect to the second printing unit 307, in the direction of feeding the paper.

The first printing unit 306 has a first thermal head 310, which is used as first print head. P1 indicates the position (printing start position) at which the heat-generating element of the head 310 is provided. Above the first thermal head 310, a platen roller 311 is arranged and used as first platen. The platen roller 311 can be rotated by a drive mechanism (not shown), in the direction of the arrow shown in FIG. 11.

The second printing unit 307 has a second thermal head 320 that is used as second print head. P2 indicates the position (printing start position) at which the heat-generating element of the head 320 is provided. Below the second thermal head 320, a second platen roller 321 is arranged and fixed in place, facing the second thermal head 320 across the paper-feeding path 304,

The width of the second platen 321, as measured in the direction of feeding the paper, is smaller than the diameter of the platen roller 311. The heat-generating element P2 of the second thermal head 320 can be arranged closer to the heat-generating element P1 of the first thermal head 310 than otherwise. The surface of the second platen 321 is covered with a low-friction member and opposed to the second thermal head 320. The surface of the second platen 321 is an arced surface 321a having a radius of curvature that is almost equal to the radius of curvature of the first platen 311.

How the printer thus configured operates to print data will be explained.

First, the distal-end part of the paper 302 is pulled from the reel unit 303 and stretched from the second printing unit 307 to the first printing unit 306. The distal-end part of the paper 302 is clamped between the first and second thermal heads 310 and 320, on the one hand, and the first platen rollers 311a and second platen 321, on the other hand.

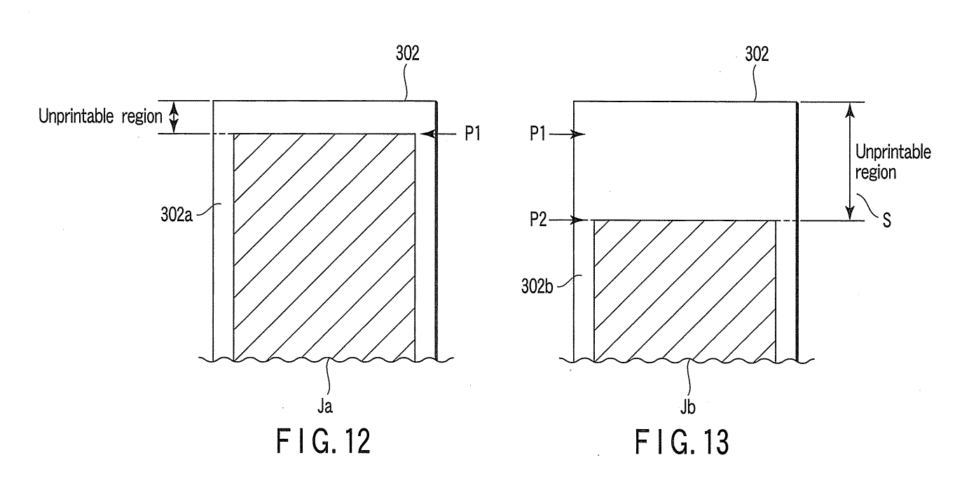

In this state, the platen roller 311 of the first printing unit 306 may be rotated in the direction of the arrow, by a drive mechanism (not shown). The paper 302 is thereby fed. The first thermal head 310 prints data Ja on one side 302a of the paper 302 as shown in FIG. 12. At the same time, the second thermal head 320 prints data Jb on the other side 302b of the paper 302 as shown in FIG. 13.

As described above, the second platen 321 is fixed in place in the present embodiment, and the width of the second platen 321, as measured in the direction of feeding the paper, is smaller than the diameter of the platen roller 311. Therefore, the heat-generating element P2 of the second thermal head 320 can be closer to the heat-generating element P1 of the first thermal head 310 than otherwise. Hence, the unprintable region S, in which no data can be printed, can be decreased. The paper 302 can therefore be less wasted. Further, an appropriate friction can be applied to the paper 302 being fed, because the second platen 321 is fixed in place. A proper tension can therefore be exerted on the paper 302. This can prevent printing errors and jamming of the paper being fed.

As indicated above, the second platen 321 has an arced surface 321a that faces the second thermal head 320 and has a radius of curvature almost equal to the radius of curvature of the first platen 311. Thus, the nip between the second thermal head 320 and the second platen 321 can be sufficiently broad, though the width of the second platen 321 is small as measured in the direction of feeding the paper 302. Thus, the printing performance would not be impaired.

Since the surface of the second platen 321 is covered with a low-friction member, the friction between the arced surface 321a and the paper 302 is low. Therefore, the second platen 321 would not prevent the feeding of the paper 302.

In the present embodiment, the surface of the second platen 321 is covered with a low-friction member. Instead, the surface of the second platen 321 may be coated with low-friction material. Alternatively, the second platen 321 may be made of low-friction material.

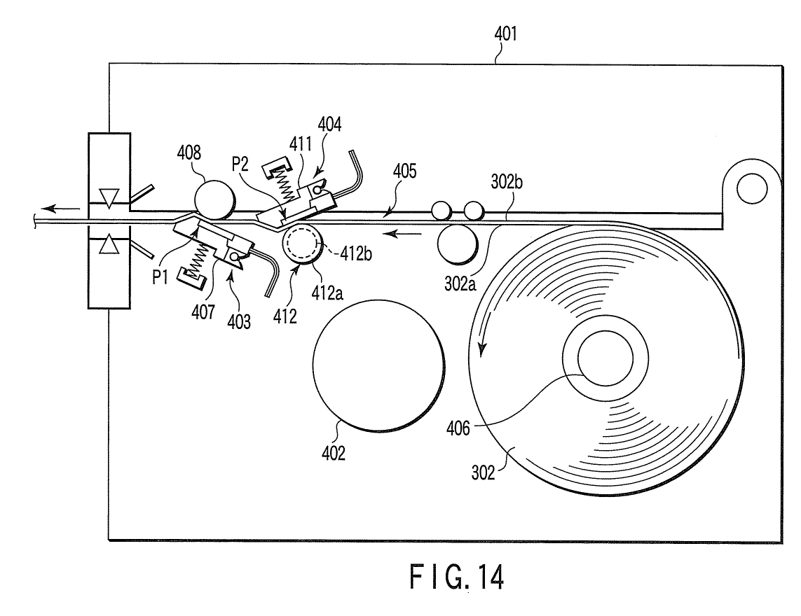

A printer according to the fifth embodiment will be described with reference to FIG. 14. This printer 401 has a drive unit 402, a first printing unit 403, a second printing unit 404, a paper-feeding path 405, and a reel unit 406. The paper-feeding path 405 is designed to feed a paper 302. The paper 302 is fed from the reel unit 406. The first printing unit 403 is arranged downstream with respect to the second printing unit 404, in the direction of feeding the paper 302. The paper 302 has a first side 302a and a second side 302b. The paper 302 is pulled along the paper-feeding path 405.

The first printing unit 403 has a first thermal head 407, i.e., first print head, and a first platen roller 408, i.e., first platen. In FIG. 14, P1 indicates the position (printing start position) at which the heat-generating element of the first thermal head 407 is provided. The first platen roller 408 is shaped like a circular column. The roller 408 is opposed to the first thermal head 407, clamping the paper 302 jointly with the first thermal head 407.

The second printing unit 404 has a second thermal head 411, i.e., second print head, and a second platen roller 412, i.e., second platen. In FIG. 14, P2 indicates the position (printing start position) at which the heat-generating element of the second thermal head 411 is provided. The second platen roller 412 has the same shape as the first platen roller 408. The second platen roller 412 is opposed to the second thermal head 411, clamping the paper 302 jointly with the second thermal head 408. The second platen roller 412 has a roller body 412a and a one-way clutch 412b. The one-way clutch 412b is incorporated in the roller body 412b.

The drive unit 402 can drive reduction gears (not shown), thereby to rotate the first platen roller 408 and the second platen roller 412. In the fifth embodiment, the rotational speed V1 of the first platen roller 408 is higher than the rotational speed V2 of the second platen roller 412. The one-way clutch 412b can make the roller body 412a run idle if the paper 302 is fed at a speed higher than the rotational speed V2 of the second platen roller 412. In this case, the second platen roller 412 acts as brake on the paper 302 through the one-way clutch 412b.

In the fifth embodiment, the second platen roller 412 acts as brake on the paper 302, applying a tension on the paper 302. The paper 302 is therefore prevented from slackening. This can prevent printing errors and jamming of the paper being fed.

The present invention is not limited to the embodiments described above. The components of any embodiment can be modified in various manners in reducing the invention to practice, without departing from the spirit or scope of the invention. Further, the components of any embodiment described above may be combined, if necessary, in various ways to make different inventions. For example, some of the component of any embodiment may not be used. Moreover, the components of the different embodiments may be combined in any desired fashion.

What is claimed is:

1. A printer in which a first print head and a first platen are opposed to a second print head and a second platen, respectively, across a paper-feeding path, and data is printed on both sides of a paper,
wherein the first platen is a platen roller which rotates to feed the paper, and the second platen is fixed in place, has an arced surface opposed to the second print head and having a radius of curvature almost equal to a radius of curvature of the first platen, and has a width as measured in the direction of feeding the paper, which is smaller than a diameter of the first platen.

2. The printer according to claim 1, wherein at least the arced surface of the second platen is covered with a low-friction member.

3. The printer according to claim 1, wherein the second platen is made of low-friction material.

4. The printer according to claim 1, wherein the second platen is located upstream with respect to the first platen, and the second platen has a surface less frictional than a surface of the first platen.

5. The printer according to claim 1, wherein the first and second print heads are thermal heads.
